(19) United States
(12) Patent Application Publication
(10) Pub. No.: US 2008/0215732 A1
(43) Pub. Date: Sep. 4, 2008

(54) MULTI-SITE SCENARIOS IN THE STORAGE AND ARCHIVING OF MEDICAL DATA OBJECTS

(76) Inventors: Thomas Haug, Herzogenaurach (DE); Thomas Dechant, Sagamore Hills, OH (US); Achim Scheidl, Nurnberg (DE)

Correspondence Address: SCHIFF HARDIN, LLP;PATENT DEPARTMENT, 6600 SEARS TOWER, CHICAGO, IL, 60606-6473, US

(21) Appl. No.: 12/030,919

(22) Filed: Feb. 14, 2008

(30) Foreign Application Priority Data
Feb. 14, 2007 (DE) 10 2007 007 326.9

(51) Int. Cl. G06F 15/173

(52) U.S. Cl. 709/225

(57) ABSTRACT

In a method, an administration system and a computer program product (computer-readable medium) for storage and archiving of medical image data and metadata in a distributed system or clinical facility, with a central server, a central archive and a number of decentralized nodes, the image data are decentrally stored at the respective nodes, and the metadata are only stored centrally on the central server.

### BACKGROUND OF THE INVENTION

1. Field of the Invention

The invention is in the field of medical technology and data processing, and in particular concerns an approach for administration (in particular for storage and for archiving) of medical image data objects in a distributed clinical facility have multiple sites.

2. Description of the Prior Art

The information technology basis of most present-day clinical facilities is a distributed system having a number of different sites with different computer-based applications. In addition to one or more central servers, different modalities (computed tomography systems, magnetic resonance tomography systems, x-ray apparatuses, etc.) and different workstations are connected. A portion thereof can be associated with a hospital department or a sub-unit of a clinical facility. Further connected sub-systems can be physician's private practices, laboratories or further hospitals. Most data today exist in digital form and should be capable of being exchanged and transferred across all units of the clinical facility.

If it is assumed that there is at least one central main administration unit (main site) and a number of computer-based notes (satellite sites) connected therewith, the known systems make provision both to store the data in a distributed manner and to archive these in a distributed manner. A decentralized storage and a decentralized archiving are thus known. In view of the fact that an enormous data volume is to be stored and archived in just the imaging medical sector, this approach inevitably leads to a very high storage space consumption that overall has a disadvantageous effect on the performance and the maintenance expenditure of the system.

In the following a known data administration system is described as an example. The SIENET MagicStore from commercially available Siemens Healthcare is an example of a known data management system for distributed systems. A central component is responsible for the administration, storage and archiving of digital x-ray images. Different image databanks (image management systems—IMS) can be connected to the central patient databank. This system is based on a distributed data storage. The data that are acquired in the framework of an (x-ray) examination are stored and administered in two different databanks. The patient data management database (PDIR) is provided that is designed for storage of all examination data sets for all patients. Moreover, specific data characteristics are stored therein with regard to each patient, for example the patient name, the birth date, the gender, the station and a patient identification number. Additionally, an image management system database (IMS) is provided that is designed for administration of images of an examination that are stored in an image memory system, for example a RAID system (Redundant Array of Independent Discs). For example, images of patients who are currently being directly examined or who have been examined recently can be stored in the IMS databank.

When queries with regard to patients are now transmitted from specific workstation computers, these are searched for in the aforementioned databases (PDIR, IMS) mentioned in the preceding. Depending on the respective input search criteria, for example, all examinations with regard to a specific patient can be searched, or it is possible to have displayed the examinations of all patients who have been examined within a specific time period. The data objects or examinations located by means of a search query can then be loaded into the memory of the respective workstation or the computer (here a MagicView workstation) in order to be further processed there in the event that this is required. In principle it is also possible to use more than one SIENET MagicStore system within a SIENET network. The images of a respective modality (CT, MR, etc.) have always been stored and archived on a specific SIENET MagicStore system.

Conventionally, however, no differentiation has been made between the image data and the metadata with regard to their storage type. Both the images and the metadata were therefore stored decentrally, multiple times locally on the respective file servers. However, in practice the previous approach has proven to be disadvantageous for a plurality of reasons. A significant disadvantage is that the conventional system has a relatively high potential for error since, given changes to a data set, all instances of the respective data set must be changed as well. However if, due to a local computer error, this change cannot be reproduced at only one of the workstations, an inconsistency that can result in severe errors already exists with regard to the data. Another disadvantage is the relatively high maintenance expenditure since, given a change, in principle all instances of the respective data set, and thus a number of local data sets, must be considered and changed as well.

### SUMMARY OF THE INVENTION

An object of the present invention is to provide a method, administration system, and a computer-readable medium with which storage and archiving of data objects representing image data and metadata can be improved with regard to the image data, in particular that can be designed to be more efficient and less error-prone.

In the following the invention is described using the solution according to the method. Advantages, features or advantageous embodiments are likewise applicable to the system and the computer-readable medium.

The above is achieved in accordance with the invention by a method for administration of medical data (comprising image data and metadata respectively associated with these) in a distributed network system or clinical facility having at least one central server and a plurality of decentralized nodes, wherein the image data are decentrally stored at the respective nodes or archived in at least one archive, and wherein the metadata are respectively stored centrally at the central server, and wherein access from a local or a remote node to the image data ensues via the respectively associated metadata that acts as a pointer to a storage location of the image data.

As used herein, “administer”, encompasses all administrative tasks with regard to medical data, which in particular include short-term storage, long-term storage, archiving, and/or an access to stored and/or archived data.

The medical data are advantageously medical examination data that have been acquired by arbitrary modalities such as, for example, with a magnetic resonance tomography system, a computed tomography system, an x-ray apparatus, or the like. The image data are normally in the DICOM format. A data object thus includes image data (the actual images of a study or examination) and metadata with regard to these image data. Metadata can be present in many different formats (for example Boolean, integer, string, etc. format types). The metadata can be patient-specific data (for example name, age, address of the patient, etc.), study-specific data (from which modality the data were acquired, type of the modality and further identifiers of the same, point in time of the examination, etc.) or further identifiers with regard to the image data.

The clinical facility normally includes a number of departments (hospital stations, laboratories, computer centers, etc.) and furthermore can be connected with arbitrary external facilities (external laboratories, physicians' practices, etc.). All computer-supported facilities are connected with one another via a network and are involved in data exchange with one another. The data technology background of the respective network can be different, such that in addition to a LAN (local area network) a WLAN (wireless local area network) or a data transfer via the Internet or via satellites as well as via mobile data media (USB stick, etc.) are possible.

The central server is typically arranged at the “main site” and comprises a data management system (for example a SIRIUS data management system), an archive or, respectively, a long-term storage (LTS) and an administration system (OPM, operation management, administrative server, for example in COSMOS systems). However, in alternative embodiments the central server can be fashioned with further modules and instances. However, advantageously only one administration server (OPM) is provided within the entire network, which distinctly reduces the costs and the administration effort in the inventive solution.

The decentralized nodes can be any computer-supported instances, computers, workstations, or more complex systems and sub-systems such as, for example, hospital departments, networks of individual or connected physicians' practices, etc. Moreover, the computer-supported nodes can be individual modalities (MR, CT etc.), databases or computer-supported workstations.

A basic concept of the present invention is the respective data objects (thus individual data sets or a composite of a number of data sets) are divided into two different categories: namely into image data and into metadata, and these different categories are handled differently with regard to their storage or archiving. In accordance with the invention, the image data are stored decentrally, thus respectively locally and redundantly multiple times on the respective nodes (normally storage instances that are associated with the respective modality), while the metadata that require only a fraction of the storage space of the image data are stored centrally on the central server. This has the advantage that, given a change of the data (normally only the metadata are changed), only a modification access is necessary. No further data sets must be dealt with. The administration expenditure can be distinctly minimized with this and it is possible to distinctly reduce the error risk due to inconsistent data. Moreover, access conflicts can be avoided.

In a preferred embodiment of the present invention all objects that belong to a study or to an examination are stored at the same file server. The file server is a computer or a computer-supported system of a connected site (satellite site) or the main site that is responsible for a central storage and data management, such that other computers (remote nodes) of the same network can access the data of the file server. Moreover, the file server ensures that the information is also provided to other users (or, respectively, nodes) via the network. The administration effort can be inventively further reduced via the feature that in principle all data objects of a study are stored on only one file server.

According to a further embodiment, the image data are always stored on one node, in particular on a file server. The storage space thus can be minimized and errors that can arise given a redundant storage of the image data are precluded.

In a further embodiment, the method has an access mechanism that ensures that image data stored on a first node can also be requested from a second node and/or are accessible therefrom. It is thereby ensured that a data exchange with regard to the image data is also possible between the decentralized nodes. The access is advantageously regulated via the central server. In the preferred embodiment this occurs by the metadata stored on the central server being queried with regard to a storage location for the queried image data.

In a further embodiment, the method uses a synchronization mechanism that ensures that no inconsistent data objects (in particular due to parallel accesses) are stored. The security of the system can thereby be increased. For example, it is precluded from the outset that one and the same patient is examined with different modalities for one and the same point in time. If such a data set should thus be stored in the system although a data set already exists for this time period and the respective patient, an error message is output. In a more complex embodiment, further checking mechanisms are provided that lead to an output of error messages, for example given impermissible deletion actions or the like.

In another embodiment, the inventive method is based on the fact that only one administration system (OPM—operation management system) is provided within the distributed network system of the clinical facility. The administration effort can therewith be distinctly decreased.

Furthermore it is possible that, in addition to an archiving of data objects, the method also comprises a de-archiving wherein data objects can be loaded from the archive.

In principle the user is given a selection possibility for access to the image data. The user can select whether the original image data should actually be displayed or whether only a miniature representation of the respective image data (as a token or thumbnail) should be displayed. The advantage is achieved that the method can be designed more flexibly and the access times can be further reduced by the loading of a miniature representation. In alternative embodiments, this configuration feature is executed not by the user but rather by the underlying application (thus automatically by the system) or by a system administrator or by other instances of the network.

The above object also is achieved by a storage medium that is designed for storage of a computer program to implement the method described above, that can be read by a computer.

### BRIEF DESCRIPTION OF THE DRAWINGS

FIG. 1 is an overview, schematic representation of a clinical network system for administration of medical data sets.

FIG. 2 is a flow chart for loading tokens and images at a workstation computer between different nodes of the network system according to a preferred embodiment of the invention.

FIG. 3 illustrates storage of images on a file server according to a preferred embodiment of the invention.

FIG. 4 is a schematic, overview representation for archiving of images according to a preferred embodiment of the invention.

FIG. 5 is a schematic, overview for de-archiving according to a preferred embodiment of the invention.

FIG. 6 is a schematic, overview for de-archiving in the event that the data objects are stored on different file servers.

### DESCRIPTION OF THE PREFERRED EMBODIMENTS

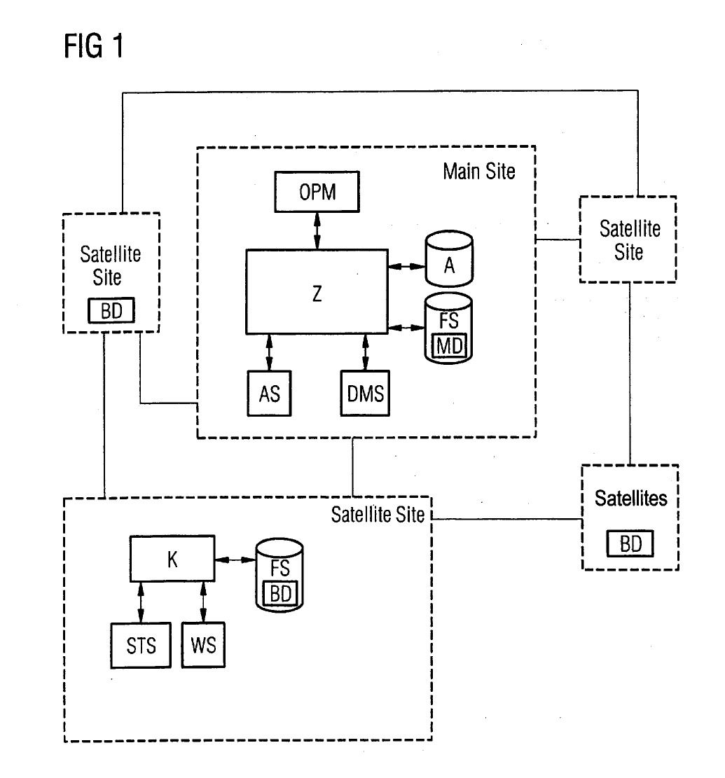

In the following the basic design of the inventive system and the basic workflow of the inventive method are illustrated in connection with FIG. 1.

The inventive method is designed for administration of data sets or data objects that also include metadata MD in addition to image data BD. The image data BD originate from modalities of different types (CT, MR, PET etc.) while the metadata MD are normally text data that represent meta-information with regard to the image objects (patient-specific data, examination-specific data, modality-specific data etc.). A data object thus includes both image data BD and metadata MD.

The inventive method is concerned with storing the image data BD decentrally (and thus locally on the respective nodes K) while the associated metadata MD are stored only centrally on the central server Z.

In FIG. 1 a central main instance (also called a main site) is integrated into an inventive network of a clinical facility that acts as a central server Z. A plurality of satellites (also called satellite sites) that likewise serve as nodes K of the network are connected to the central server Z. A data connection in the form of a network exists between the satellite nodes K and the central server Z. In the preferred embodiment the satellite nodes K are, for example, laboratories, physicians' practices or hospital departments. The main site is arranged in the main instance of the clinical facility and, in the preferred embodiment, has an application server AS in which the storage locations or addresses for data objects are administered. In the preferred embodiment the central serve (main site) Z includes the following components:

an application server AS,

a data management system, for example a SIRIUS data management system,

a central file server FS,

an archive A or a long-term storage (LTS),

an administration instance that is also designated as an operation management instance (OPM) and that is designed for administrative services and tasks.

In alternative embodiments the central server Z can include further components or it can comprise only portions of the aforementioned components. Moreover, it is possible to integrate the components into the server Z or to provide these at remote locations via data connections (or via a network) and to connect these to the server Z.

The central server Z is connected with a number of satellite sites. As likewise schematically represented in FIG. 1, each satellite node K has a local file server FS, a web server WS and advantageously a short-term storage STS. The satellite nodes can be arbitrary computer-supported workstations (in particular SIRIUS workstations) SWP. As satellite nodes K, the modalities, finding computers, laboratory computers etc. can likewise be connected to the central server Z and be involved in a data exchange therewith.

For example if, in the framework of a medical examination, x-ray images are acquired by an x-ray apparatus that is connected to the system as a node K, in accordance with the invention the respective image data BD of the x-ray images are stored in the respective local file server FS of the modality. If an assessing physician who works at another workstation SWP would now like to access these images, he or she thus sends a corresponding query to the central instance Z. The application server AS informs the querying workstation SWP of on which file server or where the queried image data BD are stored. This ensues by access to the respective metadata MD of the querying image data BD. The querying workstation SWP can thereupon immediately and directly access the file server FS on which the queried image data BD are stored. A metadata set thus unambiguously references the image data BD associated with it.

The image data BD are thus always stored on the local file server FS. In the event that it is necessary for a client to query metadata (patient-specific data, demographic data or workflow data, etc.), the client must send a query to the central application server AS that is arranged at the main site Z. The image transfer from the data management system is initiated by a query from the respective workstation SWP to the central application server AS. The application server AS initiates the transfer from the local file server FS or a remote file server FS that has stored the queried image data BD to the workstation SWP. Since the image data BD are respectively stored on the local file server FS associated with the respective site, and since it is very probable that these local image data BD will be accessed from the respective workstation of the site, this transfer ensues within the LAN.

However, it is also possible to request image data BD from a remote node K, thus from a remote site. In this case a direct connection is established from the respective node K to the respective file server FS of the remote site.

Since the high data volume primarily arises due to the image data BD, it is inventively provided that only the image data BD are loaded into an archive A while the associated metadata MD (that exhibit only a distinctly smaller and comparably negligible data volume) remain on the respective local file server and are not archived. The metadata MD also serve as pointers for the access to the respective image data in the archive A or on the respective file server FS. The image data BD are archived in the archive A that is arranged on the central server Z as a long-term storage (LTS). The central data management system DMS uses the metadata MD so to speak as a pointer, thus as an indicator of on which file server FS the image data are stored in the event that image data BD must be loaded from the archive A. This is also designated as a de-archiving process or prefetching. In the preferred embodiment it is provided that the archiving and/or the de-archiving is configurable and/or depends on the respective hospital department.

Only one administration instance OPM is advantageously provided on the central server S. All workstations and all data management services access the administration instance OPM in order to obtain administration data other data.

An RIS (radiology information system) is responsible for planning and administration of all patient examinations by all departments. The underlying network between the satellite sites and the main site advantageously possesses a sufficient bandwidth in order to be able to execute the respective data accesses at a satisfactory speed. A significant advantage of the respective solution is to be seen in that only one central database is required. Only one data management system on the central server Z is provided. Moreover, the respective nodes (also called hosts) of the distributed file system must be less elaborately equipped with regard to their computer-supported infrastructure since all essential instances are provided centralized on the central server Z. Since only one database exists, only one database license is also advantageously required. Moreover, the storage space for storage of the respective data objects can be distinctly reduced.

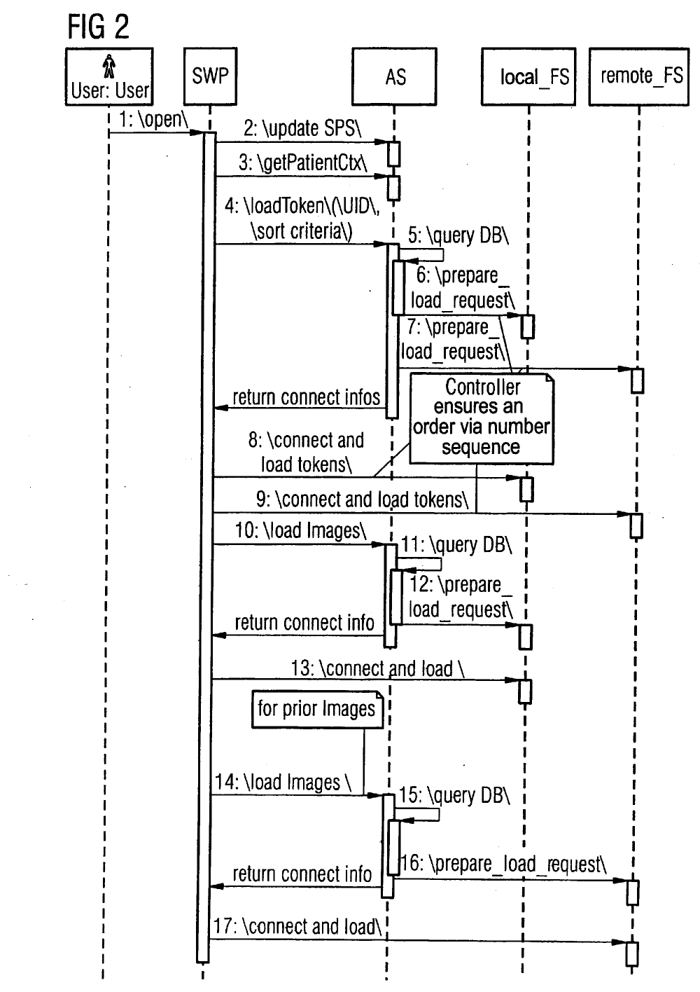

A workflow that is executed upon loading of tokens or of images onto a workstation SWP is schematically shown in FIG. 2. In the event that the user clicks on the corresponding procedure on the workstation SWP, a “getPatientContext query” and a “loadToken query” are initiated. The central data management application server AS thereupon determines on which file server(s) FS the respective image data or tokens are stored. As a result of the query an information is provided of how the respective file server FS can be addressed. This information is relayed directly and immediately to the respective workstation SWP that thereupon contacts the respective file server. The local file server FS thereupon returns the corresponding tokens or image data BD. The tokens are located in a specific order (with a corresponding numbering). This order or numbering serves so that the respective tokens or image data BD can also be displayed in the correct order on the respective workstation SWP. In the event that loading of image data BD is initiated by the user, the respective query merely need include the data objects that belong to exactly one study, since in principle only data objects of one study are stored on a file server FS. The information provided by the application server AS about the storage location (thus about the involved file server(s) FS) is provided as a query of the respective client which advantageously ensues according to the SOAP protocol. After the information is provided to the client, the client can address the respective file server FS and start the loading of the image data BD.

In the following a short depiction of the respective method steps is given with regard to the workflow shown in FIG. 2, that includes:
Step 1: The user logs onto the workstation SWP.
Step 2: Connection with the central application server AS is established.
Step 3: The patient context is acquired from the central application server AS at the workstation SWP.
Step 4: Workstation SWP queries the central application server AS for the tokens of the images of the patient.
Step 5: The central application server AS accesses the respective database in order to localize the tokens.
Step 6: Central application server AS sends the local file server FS a message that a load query has occurred. A message about the address or about the connection establishment is thereupon sent to the respective local file server FS.
Step 7: Central application server AS sends the remote file server FS a message that a load query has occurred. A message about the address or about the connection establishment is thereupon sent to the local file server FS.
Step 8: The transmitted information is used for the connection establishment so that the workstation can access the token of the local file server FS.
Step 9: The information about the connection establishment is used so that the workstation SWP contacts the remote file server FS for the queried token.
Step 10: The workstation SWP asks for the images of the patient in the central application server AS.
Step 11: Central application server accesses the database in order to localize the respective images.
Step 12: Central application server AS sends a message to the local file server FS that a load task has occurred. Information about the connection establishment is thereupon sent at the workstation SWP to the local file server FS.
Step 13: The information about the connection is used such that the workstation SWP asks the local file server FS for the images.
Step 14: Workstation SWP can moreover query the central application server AS for earlier images (from past studies of a patient).
Step 15: Central application server accesses the database in order to localize the past images.
Step 16: Central application server AS sends a message to the remote file server FS that a load task has occurred. Information about the connection with the remote file server FS is thereupon returned.
Step 17: This information about the connection establishment is used such that the workstation SWP queries the remote file server FS with regard to the images BD.

In this load workflow, it should be noted that the user is in no way limited to always loading all comprehensive image data BD. He or she can merely load the tokens as short views for the image data BD.

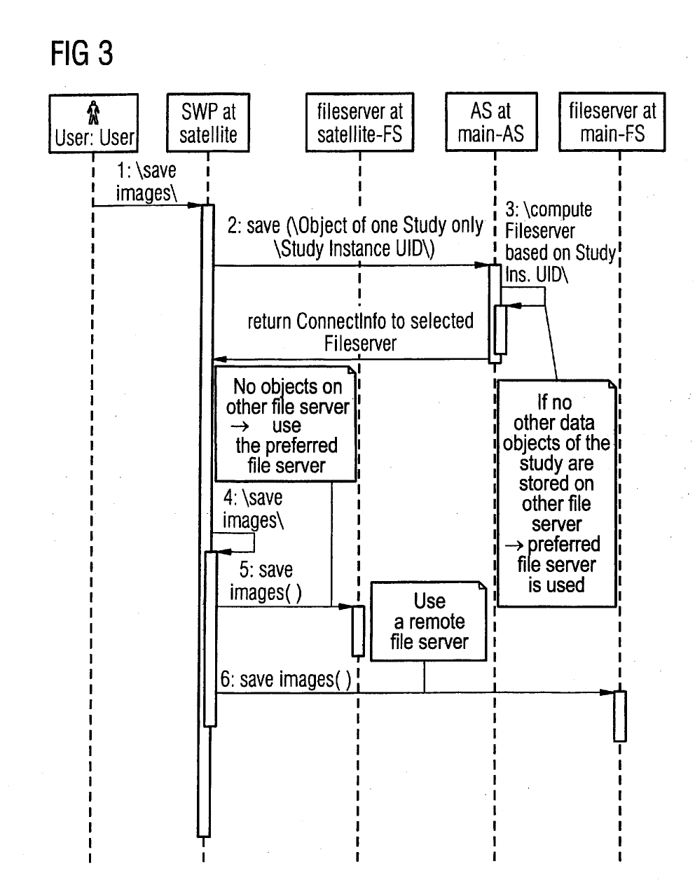

The workflow for the storage of image data BD on a local or remote file server FS is explained in FIG. 3, that includes:.
Step 1: The user saves the image data BD on his workstation SWP.
Step 2: The workstation SWP sends a storage query to the central application server AS.
Step 3: The central application server AS checks (by means of a unique study identifier (UID)) whether other data objects of the study are also stored on other file servers FS. In the event that no other data objects of the study are stored on other file servers FS, the central application server AS sends the information about the connection establishment with the preferred file server FS to the respective workstation SWP. Here the local (satellite) file server FS is thus addressed.
Step 4: Using the information, the workstation SWP saves the image data BD on the local file server FS.
Step 5: (As a variant of the steps 2, 3, 4) Otherwise, in the event that other data objects of the study exist on further file servers FS, the central application server AS sends information about the respective connection establishment with the remote file server FS (here at the main site) to the workstation SWP. The image data are then saved on the respective remote file server FS (remote file server at main site).

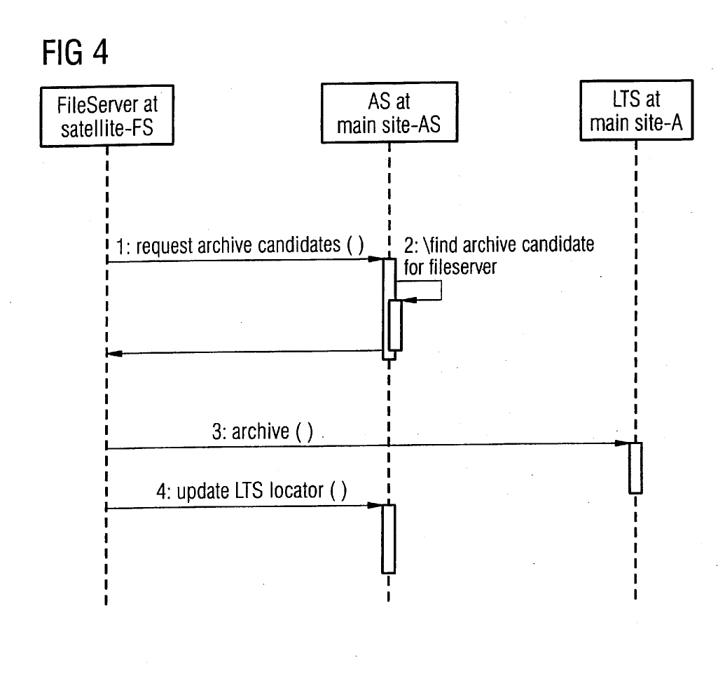

An archiving procedure of image data BD in a long-term storage LTS (which here acts as an archive A) is shown in FIG. 4, including:
Step 1: A satellite file server FS sends a query to the central application server AS that specific data objects must be archived.
Step 2: The central application server AS searches for possible data objects that should be archived in the LTS. The central application server sends the information about the possible data objects to the satellite file server FS.
Step 3: Using this information, the satellite file server FS sends the files or, respectively, data objects to the archive A for the purposes of the archiving.
Step 4: The file server FS sends a query for update for archive addresses or, respectively, of storage spaces occupied in the archive A at the central application server AS.

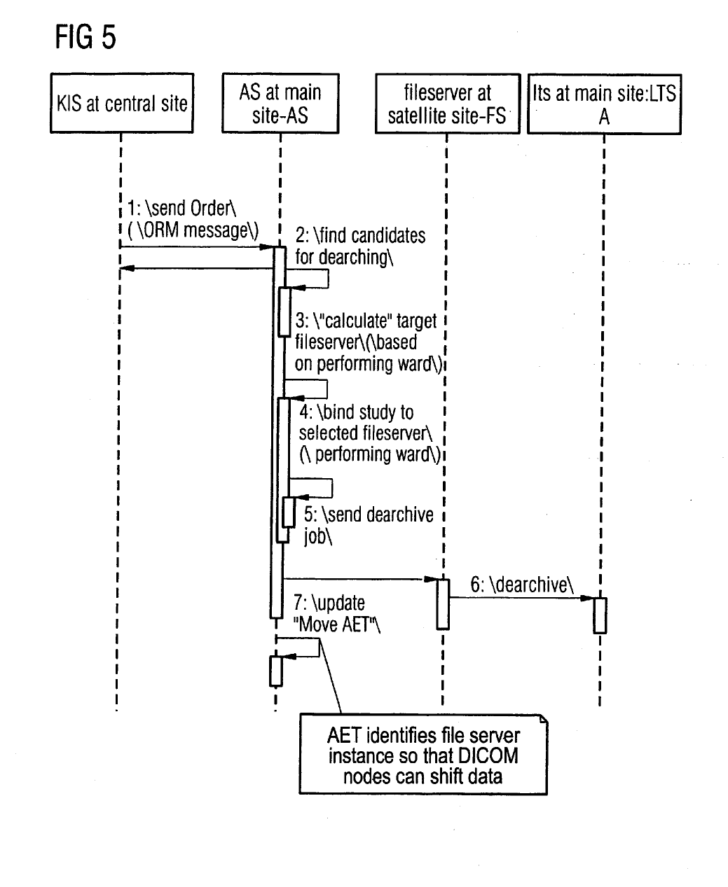

A function workflow for a de-archiving procedure is schematically shown in FIG. 5. In order to avoid repetitions, at this point the previously used Figure specifications are referenced for the description of this method workflow. However, it is noted that here a linking of the study to a selected file server FS ensues, in particular in step 4. This linking procedure ensues in the framework of a synchronization mechanism. It must be ensured that there are no parallel queries in order to modify (to save, to archive, to de-archive, to generate or to delete, etc.) the respective data set. In order to ensure consistent data, it is ensured that the respective queries are processed in a specific order.

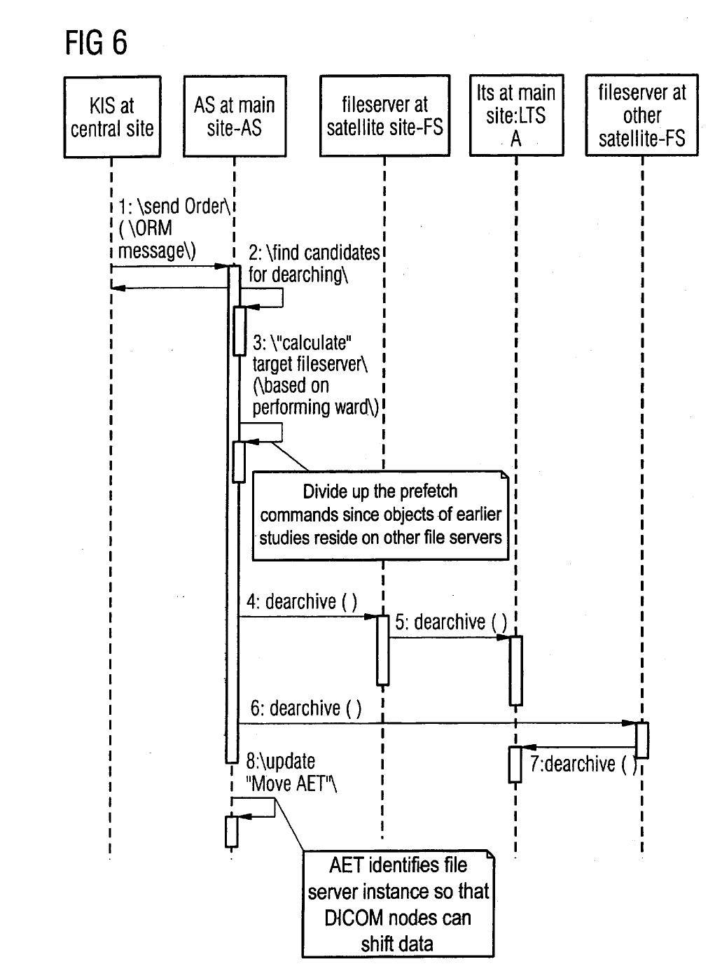

In an alternative embodiment to the embodiment shown in FIG. 5, FIG. 6 illustrates the scenario that occurs when the application server AS must send de-archiving queries to file server FS that includes the data objects of earlier studies. In FIG. 6 it is identified in the steps 4 through 7 that the de-archiving task is divided up to different instances: on the one hand, a de-archiving query is send to the central archive A and on the other hand the de-archiving query is send to another remote satellite file server FS. As a result the file servers FS de-archive the requested data objects from the central archive A.

Those skilled in the art will understand that the invention can be realized partially or entirely in software and/or hardware and/or distributed among a number of physical products (particularly computer program products).

Although modifications and changes may be suggested by those skilled in the art, it is the intention of the inventors to embody within the patent warranted hereon all changes and modifications as reasonably and properly come within the scope of their contribution to the art.

We claim as our invention:

1. A method for storing medical data comprising image data and method data in a distributed network system or clinical facility comprising a central server and a plurality of decentralized nodes in communication with said central server and an archive in communication with said central server, said method comprising the steps of:
decentrally storing only said image data at respective locations selected from the group consisting of respective ones of said nodes and said archive;
centrally storing only said method data at said central server; and
accessing desired image data from said locations by using said metadata as a pointer to a storage location of the desired image data.

2. A method as claimed in claim 1 wherein said image data represent a study comprising a plurality of data objects, and wherein said method comprises storing said data objects in a file server accessible from said central server and each of said plurality of decentralized nodes.

3. A method as claimed in claim 1 comprising selecting said location exclusively from among said plurality of decentralized nodes, and, at each of said decentralized nodes, storing said image data at a file server.

4. A method as claimed in claim 1 comprising providing an access protocol that allows image data stored at a first of said nodes to be accessible from a second of said nodes.

5. A method as claimed in claim 1 comprising synchronizing storage of said image data at said locations to preclude inconsistent data objects from being stored.

6. A method as claimed in claim 1 comprising allowing direct exchange of said image data respectively stored at a first of said nodes and a second of said nodes by providing respective addresses for the first and second nodes by accessing said central server.

7. A method as claimed in claim 1 comprising employing a single administration source to centrally administer storage of all of said medical data.

8. A method as claimed in claim 1 wherein said locations consist of said respective nodes, and comprising loading said image data to said respective nodes from said archive.

9. An administration system for storing medical data comprising image data and method data in a distributed network system or clinical facility, comprising:
a central server and a plurality of decentralized nodes in communication with said central server and an archive in communication with said central server;
said central server decentrally storing only said image data at respective locations selected from the group consisting of respective ones of said nodes and said archive;
said central server centrally storing only said method data at said central server; and
desired image data being accessed from said locations by using said metadata as a pointer to a storage location of the desired image data.

10. A computer-readable medium encoded with programming instructions for storing medical data comprising image data and method data in a distributed network system or clinical facility comprising a central server and a plurality of decentralized nodes in communication with said central server and an archive in communication with said central server, said programming instructions causing said system or facility to:
decentrally store only said image data at respective locations selected from the group consisting of respective ones of said nodes and said archive;
centrally store only said method data at said central server; and
access desired image data from said location by using said metadata as a pointer to a storage location of the desired image data.
